(19) United States
(12) Patent Application Publication
(10) Pub. No.: US 2022/0030067 A1
(43) Pub. Date: Jan. 27, 2022

(54) ENVIRONMENT INFORMATION SYSTEM

(71) Applicant: Airbus Defence and Space GmbH, TAUFKIRCHEN (DE)

(72) Inventor: Mika SEMANN, TAUFKIRCHEN (DE)

(21) Appl. No.: 17/312,325

(22) PCT Filed: Dec. 9, 2019
(86) PCT No.: PCT/EP2019/084116

§ 371 Date: Jun. 9, 2021

(30) Foreign Application Priority Data
Dec. 12, 2018 (EP) 18211949.5

(51) Int. Cl. H04L 29/08; G06N 3/02; G06K 9/62

(52) U.S. Cl. CPC H04L 67/12; G06K 9/6256; G06N 3/02

(57) ABSTRACT

A method for calculating real-time immission values at locations within an area of interest. The method comprises providing an emission dispersion model with real-time information on one or more mobile emitters, for example vehicles. The one or more mobile emitters are within an area of interest. The method further comprises providing the emission dispersion model with respective emission characteristics of the one or more mobile emitters. The method further comprises providing the emission dispersion model with information comprising influencing environmental factors on emission dispersion for an environment within the area of interest. The method further comprises calculating real-time immission values at locations within the area of interest based on the emission dispersion model. Further, a system for calculating real-time immission values at locations within an area of interest is provided.

### CROSS-REFERENCES TO RELATED APPLICATIONS

This application claims the benefit of the International Application No. PCT/EP2019/084116, filed on Dec. 9, 2019, and of the European patent application No. 18211949.5 filed on Dec. 12, 2018, the entire disclosures of which are incorporated herein by way of reference.

### FIELD OF THE INVENTION

Examples relate to concepts for calculating real-time immission values and applications thereof and, in particular, to a system and method for calculating real-time immission values caused by a mobile emitter at locations within an area of interest.

### BACKGROUND OF THE INVENTION

Systems to monitor immissions, e.g., caused by vehicles, for example noise immissions caused by aircraft in a vicinity of airports, in real time are built on top of one or more sensor stations containing sound level meters, power supply, datalink, data storage and software which processes and visualizes the corresponding data. Drawbacks of such systems are the high costs needed for installation and operating the sensor stations and the fact that immission values can only be provided for the location of the sensor stations. On top of that, the sound level meters also measure noise not only caused by the emitter in question, like an aircraft, but also from other sources, e.g., in situations with strong winds the noise level measured isn't reliable anymore.

Systems may have to be optimized with respect to costs. Nevertheless, it is desired to form systems for real time application.

There may be a demand to provide concepts for methods and systems for real-time application with reduced costs.

Such a demand may be satisfied by the subject-matter of the claims.

### SUMMARY OF THE INVENTION

According to a first aspect, a method for calculating real-time immission values at locations within an area of interest is provided. The method comprises providing an emission dispersion model with real-time information on one or more mobile emitters, for example one or more vehicles. The one or more mobile emitters are within an area of interest, for example in a vicinity of the one or more mobile emitters. The method further comprises providing the emission dispersion model with respective emission characteristics of the one or more mobile emitters. The method further comprises providing the emission dispersion model with information comprising influencing environmental factors on emission dispersion for an environment within the area of interest. The method further comprises calculating real-time immission values at locations within the area of interest based on the emission dispersion model.

In consequence, a sensor infrastructure may not be necessary. Thus, the method may save costs. Further, real-time analysis can be performed on the calculated real-time immission values. The term “emitter” may be understood herein as “emittent”, which is a source of a disturbing environmental factor, for example exhaust emittent or noise emittent.

According to a second aspect, a system for calculating real-time immission values at locations within an area of interest is provided. The system comprises a processing unit. The processing unit is configured to provide an emission dispersion model with real-time information on one or more mobile emitters, for example aircraft. The one or more mobile emitters are within an area of interest. The processing unit is further configured to provide the emission dispersion model with respective emission characteristics of the one or more mobile emitters. The processing unit is further configured to provide the emission dispersion model with information retrieved from a database. The information comprises influencing environmental factors on emission dispersion for an environment within the area of interest. The processing unit is further configured to calculate real-time immission values at locations within the area of interest based on the emission dispersion model.

The real-time immission values may be spatially or spatial-temporally distributed immission values for any location in the area of interest. The area of interest may be a vicinity of an airport or any other emitting infrastructure like roads or railroad tracks.

The emission dispersion model may describe a physical model for absorption of emission between the one or more mobile emitters and the locations within the area of interest taking into account at least a qualitative and quantitative description of the emission caused by the emitter (emission model), the dynamic location of the emitter, the environmental parameters influencing the transmission or dispersion of the emission like meteorological parameters for air damping and terrain or/and type of ground cover for ground damping. A mesh of all locations in the area of interest may form a real-time emission dispersion map. It is clear to a person skilled in the art to calculate individual noise immission values on the ground, e.g., caused by the noise emission of an aircraft in a point to point relationship taking at least some of the above mentioned parameters into account.

It is clear to a person skilled in the art that the statements set forth herein under use of hardware circuits, software means or a combination thereof may be implemented. The software means can be related to programmed microprocessors or a general computer, an ASIC (Application Specific Integrated Circuit) and/or DSPs (Digital Signal Processors). For example, the system, the database and the processing unit may be implemented partially as a computer, a logical circuit, an FPGA (Field Programmable Gate Array), a processor (for example, a microprocessor, microcontroller (μC) or an array processor)/a core/a CPU (Central Processing Unit), an FPU (Floating Point Unit), NPU (Numeric Processing Unit), an ALU (Arithmetic Logical Unit), a Coprocessor (further microprocessor for supporting a main processor (CPU)), a GPGPU (General Purpose Computation on Graphics Processing Unit), a multi-core processor (for parallel computing, such as simultaneously performing arithmetic operations on multiple main processor(s) and/or graphical processor(s)) or a DSP. It is further clear to the person skilled in the art that even if the herein-described details will be described in terms of a method, these details may also be implemented or realized in a suitable device, a computer processor or a memory connected to a processor, wherein the memory can be provided with one or more programs that perform the method, when executed by the processor. Therefore, methods like swapping and paging can be deployed.

Even if some of the aspects described above have been described in reference to the method, these aspects may also apply to the system. Likewise, the aspects described above in relation to the system may be applicable in a corresponding manner to the method.

It is also to be understood that the terms used herein are for purpose of describing individual embodiments and are not intended to be limiting. Unless otherwise defined, all technical and scientific terms used herein have the meaning which corresponds to the general understanding of the skilled person in the relevant technical field of the present disclosure; they are to be understood neither too far nor too narrow. If technical terms are used incorrectly in the present disclosure, and thus do not reflect the technical concept of the present disclosure, these should be replaced by technical terms which convey a correct understanding to the skilled person in the relevant technical field of the present disclosure. The general terms used herein are to be construed based on the definition in the lexicon or the context. A too narrow interpretation should be avoided.

It is to be understood that terms such as, e.g., “comprising” “including” or “having,” etc., mean the presence of the described features, numbers, operations, acts, components, parts, or combinations thereof, and do not exclude the presence or possible addition of one or more further features, numbers, operations, acts, components, parts or their combinations.

Although terms like “first” or “second,” etc. may be used to describe different components or features, these components or features are not to be limited to these terms. With the above terms, only one component is to be distinguished from the other. For example, a first component may be referred to as a second component without departing from the scope of the present disclosure; and a second component may also be referred to as a first component. The term “and/or” includes both combinations of the plurality of related features, as well as any feature of that plurality of the described plurality of features.

In the present case, if a component is “connected to”, “in communication with” or “accesses” another component, this may mean that it is directly connected to or directly accesses the other component; however, it should be noted that another component may be therebetween. If, on the other hand, a component is “directly connected” to another component or “directly accesses” the other component, it is to be understood that no further components are present therebetween.

### BRIEF DESCRIPTION OF THE DRAWINGS

In the following, the preferred embodiments of the present disclosure will be described with reference to the accompanying drawings; the same components are always provided with the same reference symbols.

In the description of the present disclosure, detailed explanations of known connected functions or constructions are omitted, insofar as they are unnecessarily distracting from the present disclosure; such functions and constructions are, however, understandable to the skilled person in the technical field of the present disclosure. The accompanying drawings are illustrative of the present disclosure and are not to be construed as a limitation. The technical idea of the present disclosure is to be construed as comprising, in addition to the accompanying drawings, all such modifications, variations and variants.

Other objects, features, advantages and applications will become apparent from the following description of non-limiting embodiments regarding the accompanying drawings. In the drawings, all described and/or illustrated features, alone or in any combination form the subject matter disclosed therein, irrespective of their grouping in the claims or their relations/references. The dimensions and proportions of components or parts shown in the figures are not necessarily to scale; these dimensions and proportions may differ from illustrations in the figures and implemented embodiments.

FIG. 1 schematically illustrates a method for calculating real-time immission values at locations within an area of interest; and

FIG. 2 schematically illustrates a system for calculating real-time immission values at locations within an area of interest.

### DETAILED DESCRIPTION OF THE PREFERRED EMBODIMENTS

The variants of the functional and operational aspects as well as their functional and operational aspects described herein are only for a better understanding of its structure, its functions and properties; they do not limit the disclosure to the embodiments. The figures are partially schematic, the essential properties and effects are clearly shown enlarged or scaled down in part to clarify the functions, active principles, embodiments and technical characteristics. Every operation, every principle, every technical aspect and every feature that/which is disclosed in the figures or in the text is/can be combined with all claims, each feature in the text and the other figures, other modes of operation, principles, technical refinements and features that are included in this disclosure, or result from it, so that all possible combinations are assigned to the devices and methods described. They also include combinations of all individual comments in the text, that is, in each section of the description, in the claims and combinations between different variations in the text, in the claims and in the figures, and can be made to subject-matter of further claims. The claims do not limit the disclosure and therefore the possible combinations of all identified characteristics among themselves. All features disclosed are explicitly also individually and in combination with all other features disclosed herein.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

The system and method will now be described with respect to the embodiments.

In the following, without being restricted thereto, specific details are set forth to provide a thorough understanding of the present disclosure. However, it is clear to the skilled person that the present disclosure may be used in other embodiments, which may differ from the details set out below.

The method for calculating real-time immission values at locations within an area of interest comprises providing (S112) an emission dispersion model with real-time information on one or more mobile emitters, for example aircraft. The one or more mobile emitters are within an area of interest. The method further comprises providing (S114) the emission dispersion model with respective emission characteristics of the one or more vehicles. The method further comprises providing (S116) the emission dispersion model with information comprising influencing environmental factors on emission dispersion for an environment within the area of interest. The method further comprises calculating (S120) real-time immission values at locations within the area of interest based on the emission dispersion model.

The step S110 may comprise the steps S112, S114 and S116 such that the emission dispersion model is based on the provisions in S112, S114 and S116.

The immission may, for example, be noise immission, such as unwanted sound. The emission dispersion model may then be a sound propagation model.

The information may comprise first data and second data. The first data may be dynamic data. The second data may be static data. The dynamic data may be assumed as changing over time. The static data may be assumed as not changing over time. The first and second data may comprise influencing environmental factors on emission dispersion.

The first data may comprise weather data and/or position data of the mobile emitter including information of its operational state and the type/class of the one or more mobile emitters, e.g., a position of a specific type of aircraft being in take off phase at full thrust. The first data may comprise information regarding a respective operational state of the one or more mobile emitters, for example thrust and flap settings or landing gear in or out. Where the first data does not comprise information regarding the respective operational state of the one or more mobile emitters, this respective information can be estimated based on a respective trajectory of the one or more mobile emitters.

The first data and/or (only) the information regarding the respective operational state of the one or more mobile emitters may be transmitted/provided by the respective one or more mobile emitters. In case, the first data or (only) the information regarding the respective operational state of the one or more mobile emitters is not provided, the information regarding the respective operational state of the one or more mobile emitters is calculated from a respective trajectory of the one or more mobile emitters. The respective trajectory, or in case of multiple emitters respective trajectories, may be provided separately, for example by the database. The calculation may be an estimation of the specific parameters influencing emission dispersion.

The first data may be interpolated between two or more data points allowing a higher precision or/and synchronising different data sets to each other, e.g., weather data with position data of the emitter.

The second data may comprise at least part of the weather data, land cover data and/or terrain data.

The second data may be averaged data on a specific time range. The time range may be a day, night, month or year. By using the averaged data, the calculation can be performed faster.

The terrain data may comprise data on an earth surface, influencing absorption, reflectance and/or shadowing of emission waves. The land cover data may comprise 3D building data. The 3D building data may give information on buildings within the area of interest. The 3D building data may also comprise airport data. The 3D building data may include geometrical information of the buildings within the area of interest and, for example, information on their extent. The airport data may give information on an airport premise within the area of interest.

The position data of the mobile emitter may comprise information on an overall air traffic within the area of interest. Further, the air traffic data may comprise stored information on the one or more mobile emitters, in particular aircraft. For example, the air traffic data may differ from the real-time information on the one or more vehicles. By using older information, such as recorded or/and pre-analysed air traffic data, together with new information, such as the real-time information on the one or more vehicles, the calculation of the real-time immission values can also made faster.

The weather data can comprise a wind direction, wind speed, air humidity, air temperature and/or air pressure. The weather data may be part of the static or dynamic data. The weather data may form part of the static and/or the dynamic data. Thus, the weather data may be indicated as, for example, partly static. For example, temperature may be assumed as static for the adaptation of the emission dispersion model. In this example, the wind direction, wind speed, humidity and air pressure may be dynamic However, any other combination can be assumed for providing the emission dispersion model depending on calculation effort. Less calculation effort can require that all weather data can be assumed as static. The weather data may also include an atmospheric attenuation model. The atmospheric attenuation model may be calculated beforehand the step of calculating the real-time immission values. The atmospheric attenuation model may be used in calculating the real-time immision values. By that, the calculation effort can be minimized as well.

The calculation may be performed by interpolating the specific information of the first and/or second data. The interpolation may be performed before the actual calculation of the real-time immission values.

The land cover data may comprise a type of vegetation, water areas, sealed areas and/or built up areas.

The real-time information may comprise respective trajectory data of the one or more mobile emitters.

Further, the real-time information of the one or more mobile emitters and/or the respective emission characteristics of the one or more mobile emitters may be part of a track data stream. If either one of the information is not part of the track data stream, it can be analyzed under use of the respective flight path of the one or more mobile emitters (in case of flying mobile emitters), which may be included in the aircraft trajectory data. The dynamic changes in operational states of the respective one or more mobile emitters may lead to changes in the speed profile and vertical flight profile of the respective one or more mobile emitters, in particular aircraft.

The position or trajectory data of the mobile emitter may comprise flight paths of the respective one or more aircraft. Each flight path may be described in terms of a 3D position. The real-time information may further comprise respective vehicle types of the one or more vehicles. The emission characteristics may vary from vehicle type to vehicle type. The emission characteristics may comprise information on an emission of the hull and/or the engine. The real-time information may further comprise information regarding an operation state of the one or more vehicles, for example thrust and flap settings or landing gear in or out.

The vehicle position data may be different from the vehicle trajectory data.

In particular, the vehicle trajectory data may comprise positions of the respective one or more mobile emitters. The positions may be past positions of the respective one or more mobile emitters. Further, the positions may be future positions of the respective one or more mobile emitters. The vehicle position data may comprise a current position of the respective one or more mobile emitters. Further, the static vehicle position data may comprise predicted positions of the respective one or more mobile emitters. The vehicle position data may be information on the one or more vehicles, which are foreseen to be present within the area of interest during the time of calculating the real-time immission values. Thus, the vehicle position data can be retrieved from a database and later on be used for the calculation of the real-time immission values together with the real-time information on the one or more vehicles.

The area of interest may comprise at least an airport and/or a vicinity of the airport.

The emission dispersion model may be provided by tuning parameters influencing an emission caused by the one or more vehicles.

The parameters influencing the emission dispersion may be a vehicle type of the respective one or more vehicles, engine type of the respective one or more vehicles, flight configuration of the respective one or more vehicles along a flight path (weight, speed, flap positions, position of landing gear, etc.), power setting of the respective one or more vehicles, thrust settings of the respective one or more vehicles, meteorological conditions which influence a performance of the respective one or more vehicles, a distance between the respective one or more vehicles, the weather data and a location of interest (within the area of interest), a type of ground (acoustic character of the earth surface) and/or a presence of other reflecting surfaces within the area of interest.

The locations within the area of interest may construct a dispersion map or noise immission raster data set. The dispersion map may comprise the calculated immission values at the locations within the area of interest. The locations may form a mesh with calculated immission values.

The emission dispersion model may be based on a neuronal network model.

The neuronal network model may have been trained by training data obtained by acoustic sensors and/or by training data comprising information on location and emission of the one or more vehicles.

Machine learning describes mathematical techniques which enable a system/machine to generate knowledge from experience independently.

The method may further comprise visualizing (S140) the calculated real-time immission values at the locations within the area of interest in two or three dimensions as a thematic map.

The step of visualizing may comprise continuously visualizing a video representing the calculated real-time immission values. The dispersion map may be used for this purpose.

The visualization may be in the form of color coding in the thematic map (continuously changing).

Thus, a geographical extent of immission can be represented to an end user.

The method may further comprise the step of calculating (S150) immission levels which exceed a certain immission level threshold. A number of citizens affected by immission levels higher than the immission level threshold may be estimated based on an overlap of areas having an immission level higher than the certain immission level threshold with areas having citizens. Thereby, the land cover may form the basis of this estimation.

The static data may further comprise a first portion of population data. The first portion of population data may provide information on citizens within the area of interest independent of time. Further, the dynamic data may comprise a second portion of the population data. The second portion of the population data may provide information on citizens within the area of interest dependent on time.

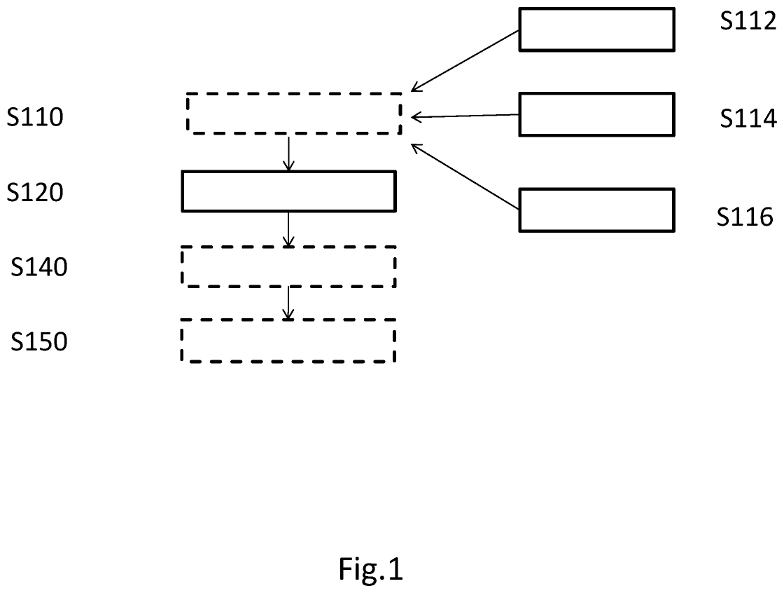

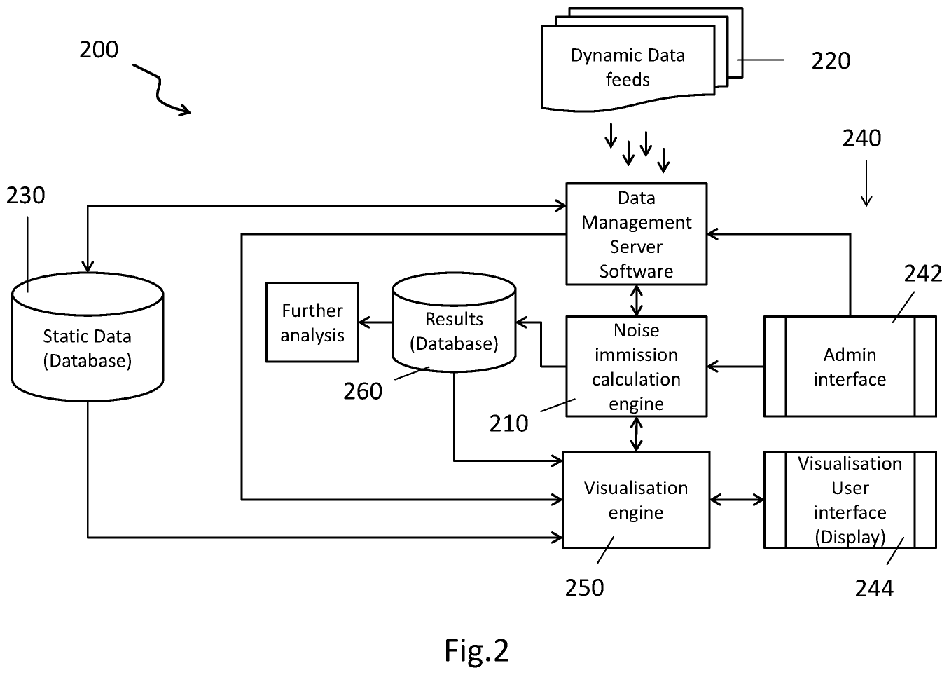

More details and aspects are mentioned in connection with the embodiments described above or below. The embodiment shown in FIG. 1 may comprise one or more optional additional features corresponding to one or more aspects mentioned in connection with the proposed concept or one or more embodiments described below (e.g., FIG. 2).

FIG. 2 schematically illustrates a system (200) for calculating real-time immission values at locations within an area of interest. The system (200) comprises a processing unit (210). The processing unit (210) is configured to provide an emission dispersion model based on real-time information on one or more vehicles, for example aircraft. The one or more vehicles are within an area of interest. The processing unit (210) is further configured to provide the emission dispersion model based on respective emission characteristics of the one or more vehicles. The processing unit (210) is further configured to provide the emission dispersion model based on information retrieved from a database (230). The information comprises influencing environmental factors on emission dispersion for an environment within the area of interest. The processing unit (210) is further configured to calculate real-time immission values at locations within the area of interest based on the emission dispersion model.

The processing unit (210) is illustrated in FIG. 2 as noise immission calculation engine (210). Further, the real-time information on one or more vehicles may be retrieved from dynamic data feeds (220). Moreover, the respective emission characteristics of the one or more vehicles may also be retrieved from the dynamic data feeds (220).

The dynamic data feeds (220) and the database (230) may be in the form of input parameters or input data. The dynamic data as described with respect to FIG. 1 may be retrieved from the data feeds (220). The static data as described with respect to FIG. 1 may be retrieved from the database (230).

The system may further comprise another database (260). The further database (260) may be used as memory. The further database (260) may be used to save results such as the calculated real-time immission values or the emission dispersion map as described with respect to FIG. 1.

The system may further comprise a user front end (240). The user front end (240) may include an admin interface (242) and a visualisation user interface, for example a display, (244). The user front end (240) may be adapted to illustrate the calculated real-time immission values or the emission dispersion map according to FIG. 1 to an end user. The admin interface (242) may exchange data with the noise immission calculation engine (210). Further exchange of data may be under use of data management server software with the static database (230). The visualisation user interface (244) may exchange data with a visualisation engine (250). The visualisation engine itself may receive data within the static database (230). Further, the visualisation engine (250) may retrieve corresponding data from the further database (260) and the noise immission calculation engine (210).

Further, the system may comprise machine knowledge. The machine knowledge may be integrated into the data management server software. The machine knowledge may be used by the noise immission calculation engine (210) or be fed to the noise immission calculation engine (210). The machine knowledge may be gathered by a machine learning engine which may be fed with training data. The training data may be part dynamic data and part static data, as described with respect to FIG. 1. Further to that, the training data may comprise sensor data or recorded immission values of specific locations within the area of interest. Thus, exact values of noise may be present for assessing the ability of the system (200).

More details and aspects are mentioned in connection with the embodiments described above or below. The embodiment shown in FIG. 2 may comprise one or more optional additional features corresponding to one or more aspects mentioned in connection with the proposed concept or one or more embodiments described above (e.g., FIG. 1) or below.

The emission dispersion model may be thought of as a “black box” which operates on input data describing a specific scenario—the airport and its air traffic—to produce an output in the form of values, such as sound levels, at discrete points (usually for a calculation grid) of specified immission metrics. These discrete points may form a mesh and may be illustrated on a map for visualization purposes for an end user.

The input data may be scenario-specific. They may define an airport geometry (i.e. description of runways and ground tracks) and air traffic using the airport (i.e. the number of movements of particular vehicle or vehicle categories on the particular ground tracks at the moment). The processing unit (210) may be a core processor that models physical processes of sound emission and propagation. The database may describe acoustic properties of the vehicle as well as its performance and operational characteristics.

The immission modeling process may be mathematically fitted to a suitable grid array of single point immission values. That array may be generated simply by repeating the single-point calculations for every grid point. For cumulative immission descriptors, each single point calculation may involve an aggregation of single event values for all emission-significant vehicle movements. Therefore, the modeling process may comprise a calculation of the vehicle event level. Traffic may be broken down into vehicle types or categories with different emission and performance characteristics which may be stored in the database (230). To minimize computation, individual vehicle types having very similar emission and performance characteristics can be grouped into representative categories. The modeling process may use between about 10 and 200 categories. However grouping may not be necessary if individual flight path information (e.g., from real-time radar data of the dynamic data feeds (220)) and/or adequate emission data is available.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A block diagram may, for instance, illustrate a high-level circuit diagram implementing the principles of the disclosure Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

The present disclosure is not limited in any way to the embodiments described above. On the contrary, there are many possibilities for modifications thereof, which are apparent to an average skilled person without departing from the underlying idea of the present disclosure as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-16. (canceled)

17. A method for calculating real-time immission values at locations within an area of interest, the method comprising:
providing an emission dispersion model with real-time information on one or more mobile emitters which are within the area of interest,
providing the emission dispersion model with respective emission characteristics of the one or more mobile emitters,
providing the emission dispersion model with information comprising influencing environmental factors on emission dispersion for an environment within the area of interest; and
calculating real-time immission values at locations within the area of interest based on the emission dispersion model.

18. The method according to claim 17,
wherein the information comprises first data and second data,
wherein the first data is dynamic data and the second data is static data,
wherein the dynamic data is assumed as changing over time, and
wherein the static data is assumed as not changing over time.

19. The method according to claim 18, wherein the first data comprises at least one of weather data, air traffic data, vehicle position data for different phases of movement, or population data.

20. The method according to claim 19, wherein the different phases of movement comprise a climb phase of respective types or classes of the one or more mobile emitters.

21. The method according to claim 19, wherein the second data comprises at least part of the at least one of weather data, land cover data or terrain data.

22. The method according to claim 18, wherein at least one of
the first data comprises information regarding a respective operational state of the one or more mobile emitters,
the first data is transmitted by the respective one or more mobile emitters, or
the information regarding the respective operational state of the one or more mobile emitters is calculated from a respective trajectory of the one or more mobile emitters.

23. The method according to claim 17, wherein the respective operation state comprises thrust and flap settings or landing gear in or out of an aircraft comprising the one or more mobile emitters.

24. The method according to claim 23, wherein the real-time information comprises respective vehicle trajectory data of the one or more mobile emitters.

25. The method according to claim 17, wherein the area of interest comprises at least one of at least an airport or at least a vicinity of the airport.

26. The method according to claim 17,
wherein, before the calculating the real-time immission values, an atmospheric attenuation model is constructed, and
wherein the atmospheric attenuation model is used in calculating the real-time immission values.

27. The method according to claim 17,
wherein the locations within the area of interest construct a dispersion map,
wherein the dispersion map comprises the calculated immission values at the locations within the area of interest, and
wherein the locations form a mesh with calculated immission values.

28. The method according to claim 17, wherein the emission dispersion model is based on a neuronal network model which has been trained by at least one of training data obtained by acoustic sensors or by training data comprising information on emission of the one or more mobile emitters.

29. The method according to claim 17, wherein the method further comprises visualizing the calculated real-time immission values at the locations within the area of interest in two or three dimensions as a thematic map or immission raster data set.

30. The method according to claim 17, wherein the visualizing comprises continuously visualizing a video representing the calculated real-time immission values.

31. The method according to claim 22,
wherein the method further comprises the calculating immission levels which exceed a certain immission level threshold,
wherein a number of citizens affected by immission levels higher than the immission level threshold is estimated based on an overlap of areas having an immission level higher than the certain immission level threshold with areas having citizens,
wherein the land cover data provides information on citizens within the area of interest.

32. A computer program product comprising program code portions for carrying out a method according to claim 17 when the computer program product is executed on one or more processing units.

33. The computer program product of claim 34 stored on one or more computer readable storage media.

34. A system for calculating real-time immission values at locations within an area of interest, the system comprising:
a processing unit configured to provide an emission dispersion model with:
real-time information on one or more mobile emitters which are within an area of interest,
respective emission characteristics of the one or more mobile emitters, and
information retrieved from at least one of a database or a data stream,
wherein the information comprises influencing environmental factors on emission dispersion for an environment within the area of interest; and
wherein the processing unit is further configured to calculate real-time immission values at locations within the area of interest based on the emission dispersion model.

35. The method according to claim 17, wherein the mobile emitters comprise vehicles.
